(19) United States
(12) Patent Application Publication
(10) Pub. No.: US 2019/0332202 A1
(43) Pub. Date: Oct. 31, 2019

(54) TOUCH DISPLAY SUBSTRATE AND TOUCH DISPLAY DRIVING METHOD

(71) Applicant: WUHAN CHINA STAR OPTOELECTRONICS TECHNOLOGY CO., LTD., Wuhan, HB (CN)

(72) Inventors: Yaoli Huang, Wuhan (CN); Xinglong He, Wuhan (CN)

(21) Appl. No.: 16/300,057

(22) PCT Filed: Sep. 27, 2018
(86) PCT No.: PCT/CN2018/108060

§ 371 Date: Nov. 8, 2018

(30) Foreign Application Priority Data
Apr. 27, 2018 (CN) 201810390116.9

(51) Int. Cl. G06F 3/044; G06F 3/041; G06F 3/047

(52) U.S. Cl. CPC G06F 3/044; G06F 3/047; G06F 3/0412

(57) ABSTRACT

The invention provides a touch display substrate and touch display driving method. The touch display substrate comprises: a substrate, a common voltage compensation circuit, an electrode array and a TDDI circuit, and first, second and third lead wires disposed on the substrate; the electrode array comprising a plurality of electrode units; the common voltage compensation circuit comprising a plurality of switching units; each electrode unit being electrically connected to an output end of switching unit and the TDDI circuit through a first lead wire, and input ends of the switching units being electrically connected to the TDDI circuit through the second lead wires; the switching unit turning on during display phase, the TDDI circuit simultaneously loading a common voltage signal to the first and second lead wires to achieve a dual-ended drive to reduce the common voltage signal difference on the electrode units to enhance the display effect.

### BACKGROUND OF THE INVENTION

### 1. Field of the Invention

The present invention relates to the field of display, and in particular to a touch display substrate and touch display driving method.

### 2. The Related Arts

The touch panel provides a new human-machine interface that is more straightforward and user-friendly. The touch panel and the liquid crystal display (LCD) panel are integrated to form a touch display panel able to provide the LCD panel with a touch function so that the user can perform an input operation through a finger, a stylus, and the like, and the operation is more intuitive and simpler.

Touch display panels can be divided into resistive, capacitive, optical, and acoustic waves types according to different sensing technologies. Currently, the mainstream touch technology is capacitive. The touch display panel can also be divided into: an embedded touch display panel and an add-on touch display panel according to different structures. For the add-on touch display panel, the touch panel and the liquid crystal display panel are separately produced, and then fit together to form a display panel with a touch function. The add-on touch display panel has higher manufacturing cost and lower light transmittance, thicker modules and other shortcomings. The embedded touch display panel embeds the touch panel function into the liquid crystal display panel, so that the liquid crystal display panel has the functions of displaying and sensing the touch input at the same time. Compared to the add-on touch display panel, the embedded touch display panel has the advantages of lower cost and less thickness, and is favored by major panel manufacturers.

Moreover, the embedded touch display panel is further divided into two types according to different positions of the touch circuit embedded in the liquid crystal display panel: the On-Cell type wherein the touch circuit is on the liquid crystal cell, and the In-Cell type wherein the touch circuit is in the liquid crystal cell. Compared with the On-Cell touch display panel, the In-Cell touch display panel can realize the thinner and lighter panel, and has been adopted by the majority of mobile phone manufacturers and evolved into the mainstream of the future touch technology. In the In-Cell touch display panel, the touch layer is shared with the common electrode (Vcom) layer of the liquid crystal display panel. Specifically, the common electrode layer covered by the entire surface is divided into a plurality of electrode units arranged in an array. The plurality of electrode units is electrically connected to a touch and display driver integration (TDDI) through a lead wire. When driving, the frame time is divided into a display phase and a touch sensing phase. In the display phase, the TDDI chip provides a common voltage signal (Vcom) to each of the electrode units through the lead wire for screen display, and the TDDI chip provides a touch sensing signal to each electrode unit through the lead wire during the touch sensing phase for touch sensing.

Since the distance between each electrode unit and the TDDI chip is different, the length of the lead wire connecting the electrode unit and the TDDI chip is different. For the electrode unit near the TDDI chip, the required lead wire is short, the resistance of the lead wire is small, while the lead wire length required for the electrode unit far from the TDDI is long, and the resistance of the lead wire is large. In the display phase, the Vcom is transmitted through the lead wire, and each lead wire having a different resistance can cause inconsistency in the Vcom on different electrode units, resulting in difference in display effects.

### SUMMARY OF THE INVENTION

The object of the present invention is to provide a touch display substrate, able to reduce the difference of common voltage signals on different electrode units to improve the display effect.

Another object of the present invention is to provide a touch display driving method, able to reduce the difference of common voltage signals on different electrode units to improve the display effect.

To achieve the above object, the present invention provides a touch display substrate, which comprises: a substrate, a common voltage compensation circuit, an electrode array and a touch display driving integrated circuit (TDDI circuit) all sequentially arranged on the substrate, and a first lead wire, a second lead wire, and a third lead wire disposed on the substrate;

the electrode array comprising a plurality of electrode units arranged in an array, and one first lead wire being disposed corresponding to each of the electrode units, and the common voltage compensation circuit comprising a plurality of switching units respectively corresponding to the plurality of electrode units;

each of the electrode units being electrically connected to an output end of the corresponding switching unit and the TDDI circuit through the corresponding first lead wire, and input ends of the plurality of switching units being electrically connected to the TDDI circuit through the second lead wires; control ends of the plurality of switch units being electrically connected to the TDDI circuit through the third lead wires;

the TDDI circuit being configured to control the switching unit to turn on during a display phase, and simultaneously load a common voltage signal to the first lead wire and the second lead wire, and control the switching unit to turn off during a touch sensing phase, and load a touch sensing signal to the first lead wire.

The TDDI circuit comprises: a first pin electrically connected to the second lead wire, a plurality of second pins electrically connected to the plurality of first lead wires respectively, and a third pin electrically connected to the third lead wire.

The second lead wire is electrically connected to the input end of each switching unit via the first pin from one side of the electrode array.

The third lead wire is electrically connected to the control end of each switching unit via the third pin from one side of the electrode array.

The TDDI circuit further comprises: a fourth pin electrically connected to the second lead wire.

The second lead wire is electrically connected to the input end of each switching unit via the first pin from one side of the electrode array, and then electrically connected to the fourth pin from the other side of the electrode array.

The TDDI circuit further comprises: a fifth pin electrically connected to the third lead wire.

The third lead wire is electrically connected to the control end of each switching unit via the third pin from one side of the electrode array, and then electrically connected to the fifth pin from the other side of the electrode array.

The touch display substrate further comprises an electrostatic protection circuit, the electrostatic protection circuit is disposed on a side of the substrate where the common voltage compensation circuit is away from the electrode array, and the plurality of first lead wires are electrically connected to the electrostatic protection circuit.

The present invention also provides a touch display driving method, applicable to the above touch display substrate, comprising:

Step S1: entering the display phase, the switching unit being turned on, the TDDI circuit simultaneously loading a common voltage signal to the first lead wire and the second lead wire, and loading the common voltage signal into the electrode unit;

Step S2: entering the touch sensing phase, the switching unit being turned off, the TDDI circuit loading the touch sensing signal to the first lead wire, and loading the touch sensing signal into the electrode unit.

The present invention provides the following advantages: the present invention provides a touch display substrate, the touch display substrate comprises: a substrate, a common voltage compensation circuit, an electrode array and a touch display driving integrated circuit (TDDI circuit) all sequentially arranged on the substrate, and a first lead wire, a second lead wire, and a third lead wire disposed on the substrate; the electrode array comprising a plurality of electrode units arranged in an array, and one first lead wire being disposed corresponding to each of the electrode units, and the common voltage compensation circuit comprising a plurality of switching units respectively corresponding to the plurality of electrode units; each of the electrode units being electrically connected to an output end of the corresponding switching unit and the TDDI circuit through the corresponding first lead wire, and input ends of the plurality of switching units being electrically connected to the TDDI circuit through the second lead wires; control ends of the plurality of switch units being electrically connected to the TDDI circuit through the third lead wires; the switching unit being turned on during a display phase, and the TDDI circuit simultaneously loading a common voltage signal to the first lead wire and the second lead wire to achieve a dual-ended drive to reduce the difference in the common voltage signal on the electrode units to enhance the display effect. The present invention also provides a touch display driving method, able to reduce the difference of the common voltage signals on different electrode units to improve the display effect.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the structure of a touch display panel substrate of the first embodiment of the present invention;

FIG. 2 is a schematic view showing the structure of a touch display panel substrate of the second embodiment of the present invention;

FIG. 3 is a schematic view showing the flowchart of the touch display driving method of the present invention.

### DETAILED DESCRIPTION OF THE PREFERRED EMBODIMENTS

To further explain the technical means and effect of the present invention, the following refers to embodiments and drawings for detailed description.

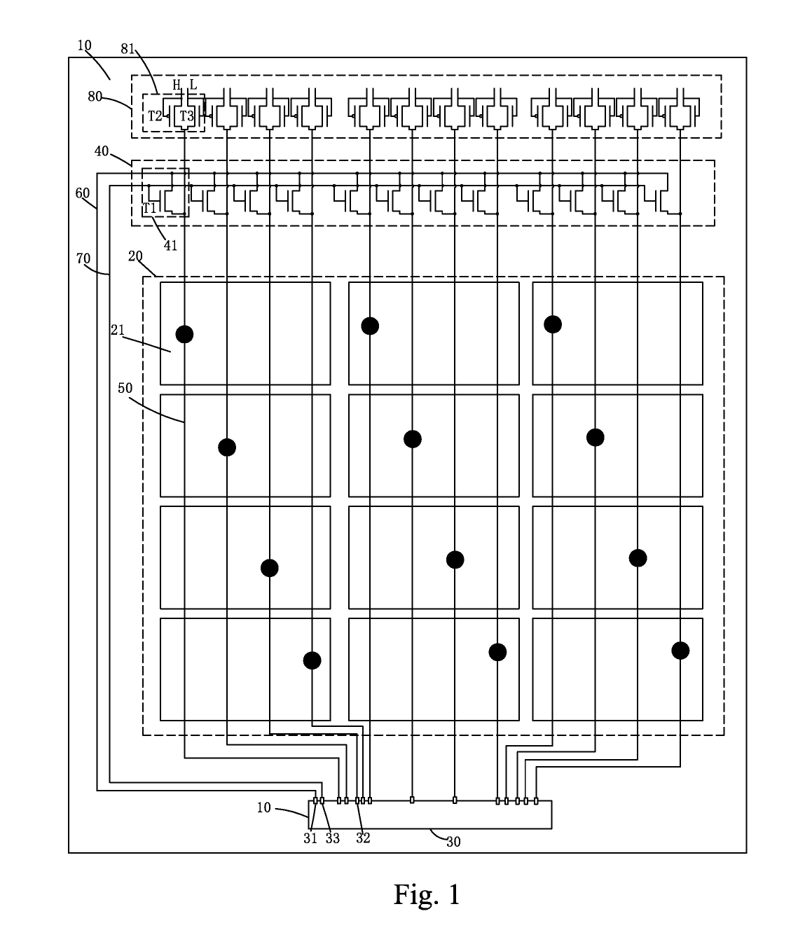

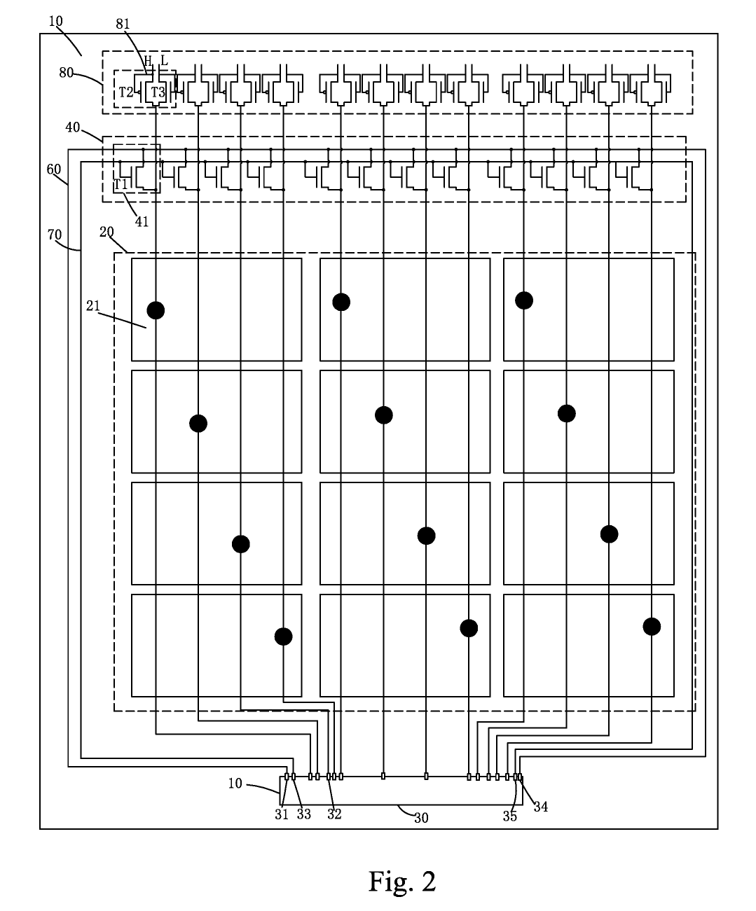

Refer to FIG. 1 and FIG. 2. The present invention provides a touch display substrate, comprising: a substrate 10, a common voltage compensation circuit 40, an electrode array 20 and a touch display driving integrated circuit (TDDI circuit) 30 all sequentially arranged on the substrate 10, and a first lead wire 50, a second lead wire 60, and a third lead wire 70 disposed on the substrate 10;

the electrode array 20 comprising a plurality of electrode units 21 arranged in an array, and one first lead wire 50 being disposed corresponding to each of the electrode units 21, and the common voltage compensation circuit 40 comprising a plurality of switching units 41 respectively corresponding to the plurality of electrode units 21; each of the electrode units 21 being electrically connected to an output end of the corresponding switching unit 41 and the TDDI circuit 30 through the corresponding first lead wire 50, and input ends of the plurality of switching units 41 being electrically connected to the TDDI circuit 30 through the second lead wires 60; control ends of the plurality of switch units 41 being electrically connected to the TDDI circuit 30 through the third lead wires 70; the TDDI circuit 30 being configured to control the switching unit 41 to turn on during a display phase, and simultaneously load a common voltage signal to the first lead wire 50 and the second lead wire 60, and control the switching unit 41 to turn off during a touch sensing phase, and load a touch sensing signal to the first lead wire 50.

It should be noted that the touch display substrate of the present invention is used to form an In-Cell type touch display panel, and the In-Cell touch display panel comprises the touch display substrate of the present invention, an opposite substrate disposed opposite to the touch display substrate, and a liquid crystal layer between the touch display substrate and the opposite substrate. A pixel electrode and a TFT for driving the pixel electrode are formed on the opposite substrate. The pixel electrode and the electrode unit operate in collaboration to drive the liquid crystal molecules the liquid crystal layer to rotate to realize an image displaying.

Optionally, as shown in FIG. 1, in the first embodiment of the present invention, the TDDI circuit 30 comprises: a first pin 31 electrically connected to the second lead wire 60, a plurality of second pins 32 electrically connected to the plurality of first lead wires 50 respectively, and a third pin 33 electrically connected to the third lead wire 70.

Moreover, the second lead wire 60 is electrically connected to the input end of each switching unit 41 via the first pin 31 from one side of the electrode array 20.

Moreover, the third lead wire 70 is electrically connected to the control end of each switching unit 41 via the third pin 33 from one side of the electrode array.

Optionally, as shown in FIG. 2, in the second embodiment of the present invention, the TDDI circuit 30 further comprises: a first pin 31 and a fourth pin 34 electrically connected to the second lead wire 60, a plurality of second pins 32 electrically connected to the plurality of first lead wires 50 respectively, and a third pin 33 and a fifth pin 35 electrically connected to the third lead wire 70.

Moreover, in the second embodiment of the present invention, the second lead wire 60 is electrically connected to the input end of each switching unit 41 via the first pin 31 from one side of the electrode array 20, and then electrically connected to the fourth pin 34 from the other side of the electrode array 20.

Moreover, in the second embodiment of the present invention, the third lead wire 70 is electrically connected to the control end of each switching unit 41 via the third pin 33 from one side of the electrode array 20, and then electrically connected to the fifth pin 35 from the other side of the electrode array 20.

In the second embodiment of the present invention, the second lead 60 and the third lead 70 are both routed simultaneously on both sides of the electrode array 20, and simultaneously provide signals through two pins. Compared to the first embodiment, wherein the second lead wire 60 and the third lead wire 70 are routed only on one side of the electrode array 20, the second embodiment can reduce the impedance on the second lead wire 60 and the third lead wire 70, and improve the accuracy of signal transmission.

Obviously, the present invention is not limited to the above two embodiments. In other embodiments of the present invention, one of the second lead wire 60 and the third lead wire 70 may be selected to be simultaneously routed on both sides of the electrode array 20 as needed. The other embodiment may be only routed on one side of the electrode array 20. None of the embodiments affects the implementation of the present invention.

Preferably, the switching unit 41 comprises a first thin film transistor (TFT) T1. A gate, a source and a drain of the first TFT T1 serve as a control end, an input end and an output end of the switching unit 41, respectively. The TDDI circuit 30 supplies a control signal to the switching unit 41 through the third lead wire 70 to control the switching of the switching unit 41. For example, in the first and second embodiments of the present invention, when the first TFT T1 is an N-type TFT, the TDDI circuit 30 supplies a high voltage control signal to the gate of the first TFT T1 during the display phase, and controls the first TFT T1 is turned on, and in the touch sensing phase, a low voltage control signal is supplied to the gate of the first TFT T1 to control the first TFT T1 to be turned off.

Specifically, as shown in FIG. 1 and FIG. 2, the touch display substrate further comprises an electrostatic protection circuit 80, the electrostatic protection circuit 80 is disposed on a side of the substrate 10 where the common voltage compensation circuit 40 is away from the electrode array 20, and the plurality of first lead wires 50 are electrically connected to the electrostatic protection circuit 80.

Moreover, as shown in FIG. 1 and FIG. 2, the electrostatic protection circuit 80 is configured to prevent the electrode unit 21 from being electrostatically damaged. The electrostatic protection circuit 80 comprises a plurality of electrostatic protection units 81, and each of the electrostatic protection units 81 corresponds to a first lead wire 50. Each of the electrostatic protection units 81 comprises a second TFT T2 and a third TFT T3, the second TFT T2 is a P-type TFT, and the third TFT T3 is an N-type. The source and the gate of the second TFT T2 are connected to a high voltage signal H, and the drain of the second TFT T2 and the drain of the third TFT T3 are electrically connected to the corresponding first lead wire 50, the source and the gate of the third TFT T3 are both connected to a low voltage signal L.

It should be noted that the touch display substrate operation process of the present invention comprises: in the display stage, the TDDI circuit 30 controls the respective switching units 41 to be turned on by the third lead wire 70, and simultaneously loading a common voltage signal to the first lead wire 50 and the second lead wire 60. The common voltage signal input to the first lead wire 50 by the TDDI circuit 30 is directly loaded onto the electrode unit 21, and the common voltage loaded onto the second lead wire 60, after the signal is input to the first lead wire 50 via the switching unit 41, is also loaded onto the electrode unit 21, thereby enabling simultaneous loading of the common voltage signal by the common voltage compensation circuit 40 and the TDDI circuit 30 to the electrode unit 21 to realize dual-end driving of the common voltage signal to reduce the difference of the common voltage signal on different electrode units, thereby improving the display effect. In the touch sensing stage, the TDDI circuit 30 controls each of the switching units 41 to be turned off through the third lead wire 70 to prevent a common voltage signal on the second lead wire 60 from being input to the first lead wire 50 to interfere with touch sensing, and the TDDI circuit 30 inputs a touch sensing signal to each of the electrode units 21 via the first lead wire 50 for touch sensing.

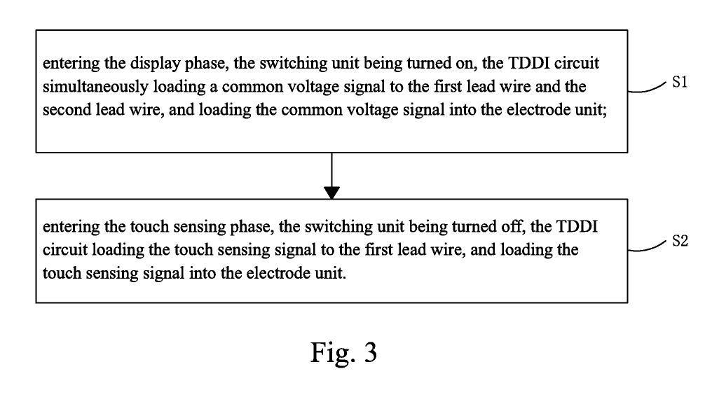

Referring to FIG. 3, the present invention also provides a touch display driving method, applicable to the above touch display substrate, comprising:

Step S1: entering the display phase, the switching unit 41 being turned on, the TDDI circuit 30 simultaneously loading a common voltage signal to the first lead wire 50 and the second lead wire 60, and loading the common voltage signal into the electrode unit 21;

Step S2: entering the touch sensing phase, the switching unit 41 being turned off, the TDDI circuit 30 loading the touch sensing signal to the first lead wire 50, and loading the touch sensing signal into the electrode unit 21.

In summary, the present invention provides a touch display substrate, the touch display substrate comprises: a substrate, a common voltage compensation circuit, an electrode array and a touch display driving integrated circuit (TDDI circuit) all sequentially arranged on the substrate, and a first lead wire, a second lead wire, and a third lead wire disposed on the substrate; the electrode array comprising a plurality of electrode units arranged in an array, and one first lead wire being disposed corresponding to each of the electrode units, and the common voltage compensation circuit comprising a plurality of switching units respectively corresponding to the plurality of electrode units; each of the electrode units being electrically connected to an output end of the corresponding switching unit and the TDDI circuit through the corresponding first lead wire, and input ends of the plurality of switching units being electrically connected to the TDDI circuit through the second lead wires; control ends of the plurality of switch units being electrically connected to the TDDI circuit through the third lead wires; the switching unit being turned on during a display phase, and the TDDI circuit simultaneously loading a common voltage signal to the first lead wire and the second lead wire to achieve a dual-ended drive to reduce the difference in the common voltage signal on the electrode units to enhance the display effect. The present invention also provides a touch display driving method, able to reduce the difference of the common voltage signals on different electrode units to improve the display effect.

It should be noted that in the present disclosure the terms, such as, first, second are only for distinguishing an entity or operation from another entity or operation, and does not imply any specific relation or order between the entities or operations. Also, the terms “comprises”, “include”, and other similar variations, do not exclude the inclusion of other non-listed elements. Without further restrictions, the expression “comprises a . . . ” does not exclude other identical elements from presence besides the listed elements.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A touch display substrate, comprising: a substrate, a common voltage compensation circuit, an electrode array and a touch display driving integrated circuit (TDDI circuit) all sequentially arranged on the substrate, and a first lead wire, a second lead wire, and a third lead wire disposed on the substrate;
the electrode array comprising a plurality of electrode units arranged in an array, and one first lead wire being disposed corresponding to each of the electrode units, and the common voltage compensation circuit comprising a plurality of switching units respectively corresponding to the plurality of electrode units;
each of the electrode units being electrically connected to an output end of the corresponding switching unit and the TDDI circuit through the corresponding first lead wire, and input ends of the plurality of switching units being electrically connected to the TDDI circuit through the second lead wires; control ends of the plurality of switch units being electrically connected to the TDDI circuit through the third lead wires;
the TDDI circuit being configured to control the switching unit to turn on during a display phase, and simultaneously load a common voltage signal to the first lead wire and the second lead wire, and control the switching unit to turn off during a touch sensing phase, and load a touch sensing signal to the first lead wire.

2. The touch display substrate as claimed in claim 1, wherein the TDDI circuit comprises: a first pin electrically connected to the second lead wire, a plurality of second pins electrically connected to the plurality of first lead wires respectively, and a third pin electrically connected to the third lead wire.

3. The touch display substrate as claimed in claim 2, wherein the second lead wire is electrically connected to the input end of each switching unit via the first pin from one side of the electrode array.

4. The touch display substrate as claimed in claim 2, wherein the third lead wire is electrically connected to the control end of each switching unit via the third pin from one side of the electrode array.

5. The touch display substrate as claimed in claim 2, wherein the TDDI circuit further comprises: a fourth pin electrically connected to the second lead wire.

6. The touch display substrate as claimed in claim 5, wherein the second lead wire is electrically connected to the input end of each switching unit via the first pin from one side of the electrode array, and then electrically connected to the fourth pin from the other side of the electrode array.

7. The touch display substrate as claimed in claim 2, wherein the TDDI circuit further comprises: a fifth pin electrically connected to the third lead wire.

8. The touch display substrate as claimed in claim 7, wherein the third lead wire is electrically connected to the control end of each switching unit via the third pin from one side of the electrode array, and then electrically connected to the fifth pin from the other side of the electrode array.

9. The touch display substrate as claimed in claim 1, wherein the touch display substrate further comprises an electrostatic protection circuit, the electrostatic protection circuit is disposed on a side of the substrate where the common voltage compensation circuit is away from the electrode array, and the plurality of first lead wires are electrically connected to the electrostatic protection circuit.

10. A touch display driving method, applicable to the touch display substrate as claimed in claim 1, comprising:
Step S1: entering the display phase, the switching unit being turned on, the TDDI circuit simultaneously loading a common voltage signal to the first lead wire and the second lead wire, and loading the common voltage signal into the electrode unit;
Step S2: entering the touch sensing phase, the switching unit being turned off, the TDDI circuit loading the touch sensing signal to the first lead wire, and loading the touch sensing signal into the electrode unit.
